(19) United States
(12) Patent Application Publication
(10) Pub. No.: US 2014/0246431 A1
(43) Pub. Date: Sep. 4, 2014

(54) CUP HOLDERS FOR ELECTRONIC DEVICES

(71) Applicant: Erik Lipson, Philadelphia, PA (US)

(72) Inventor: Erik Lipson, Philadelphia, PA (US)

(21) Appl. No.: 14/196,439

(22) Filed: Mar. 4, 2014

Related U.S. Application Data
(60) Provisional application No. 61/772,427, filed on Mar. 4, 2013.

(51) Int. Cl. F16M 13/02

(52) U.S. Cl. CPC F16M 13/02
USPC 220/212; 220/705; 239/33; 156/60

(57) ABSTRACT

Devices for removably supporting a cell phone above a disposable beverage cup while a user sips the beverage, include a looped straw and a phone supporting bracket formed on the top surface of a lid for the cup.

### CROSS-REFERENCE TO RELATED APPLICATION

This application claims priority of U.S. Patent Application 61/772,427 filed Mar. 4, 2013, the contents of which are incorporated herein by reference.

### FIELD OF THE INVENTION

This invention relates to disposable drinking cups which include means for supporting mobile electronic devices, and cell phones in particular, so that the devices may be viewed and used while beverages are consumed from the cups.

### BACKGROUND OF THE INVENTION

It is common to see patrons of restaurants, and in particular fast food restaurants, utilize their cell phones, mini pads, or the like while eating at the restaurants and in particular while consuming beverages. Specialized drinking cups, which usually involve straws for drinking the beverages, which would support such electronic devices for viewing, would provide a convenience for these patrons and their offering by restaurants, and particularly fast food restaurants, would provide an attraction for customers.

### SUMMARY OF THE INVENTION

Accordingly, the present invention relates to drinking cups for beverages which provide supports for electronic devices either by the configuration of straws associated with the drinking cups or by the cup covers.

In certain embodiments of the invention, which will be subsequently disclosed in detail, an electronic device holder is provided in the form of a unique drinking straw looped in such a way as to provide a holder for a cell phone or the like and having two ends, one extending downward from the holder for insertion into a beverage cup and a second projecting beyond the front of the cell phone holding section for the user to sip the beverage while observing and utilizing the cell phone.

In alternative embodiments of the invention a disposable cap for beverage containers provides a recess which may support the lower end of a cell phone in an upright manner so that it extends substantially perpendicularly above the top surface of the cup and thus may be observed and utilized while the beverage in the cup is consumed through a straw extending through the container top.

In still another embodiment of the invention the top of a beverage container may be provided with a volume of manually deformable plastic with a pressure-sensitive surface which retains the cell phone in contact with the cover. The pressure-sensitive device may be designed to support phones of different bottom configurations.

### BRIEF DESCRIPTION OF THE DRAWINGS

A more detailed understanding of the present invention and its objects, advantages, and applications, will be made apparent by reference to the accompanying detailed description of these preferred embodiments. The description makes reference to the accompanying drawings in which:

FIG. 1 is an illustration of a first embodiment of the invention taking the form of a looped straw which provides support for a cell phone in an upright manner above the beverage cup;

FIG. 2 illustrates a second embodiment of the invention wherein a pocket for receiving the lower end of the cell phone is incorporated in the upper side of a disposable cover for a beverage container which has a built-in straw; and

FIG. 3 is an illustration of a cell phone supported above the top of a disposable beverage lid by means of a pressure-sensitive adhesive which may take the form of a material which may be molded by depressing the lower end of the cell phone against the material, thereby accommodating cell phones of various dimensions, wherein the material has an adhesive-like quality.

### DETAILED DESCRIPTION OF A PREFERRED EMBODIMENT OF THE INVENTION

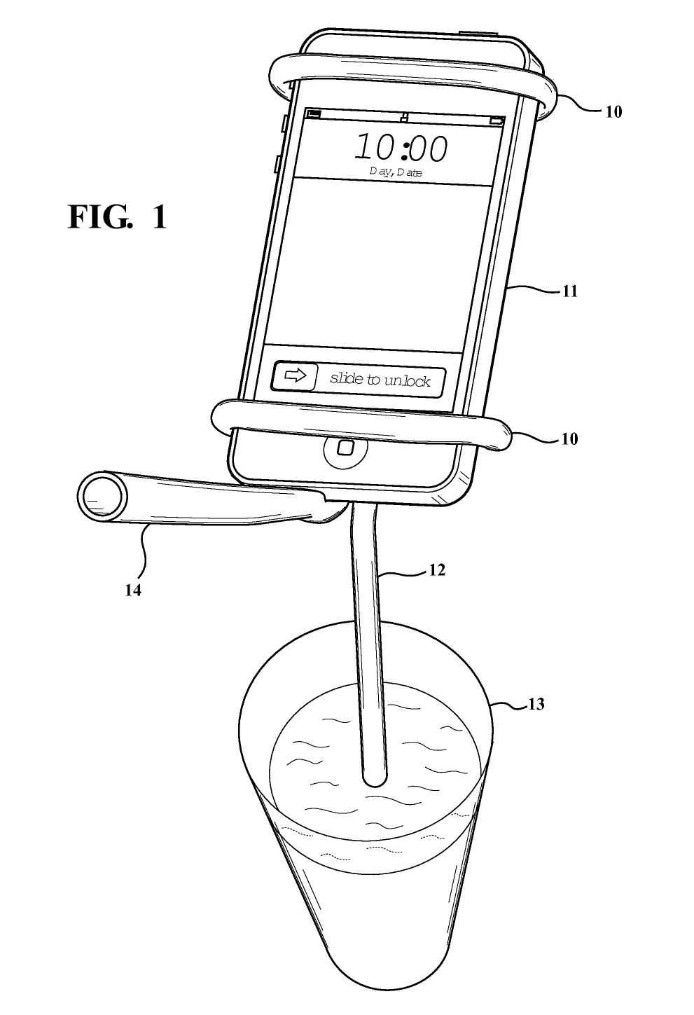

A first embodiment of my invention, illustrated in FIG. 1, comprises a conventional transparent plastic drinking straw molded during production so as to have two parallel loops 10 formed along its length. Each loop has an enclosed area suitable for surrounding a conventional rectangular cell phone such as 11. The loops are separated from one another so that one loop may extend adjacent the top of the cell phone 11 while the other loop extends adjacent the bottom of the cell phone. The cell phone may be easily inserted through the top loop 10 so that its bottom is surrounded by the lower loop 10. One end of the straw extends downwardly from the bottom loop 10 for insertion into a beverage container such as 13. The other end of the straw extends under the lower loop 10, to support the phone or the like, and projects generally forward and perpendicularly to the cell phone 11 when it is inserted in the loops, to form a sipping end to the straw.

This allows a user to sip beverage from the container 13 through the straw while viewing the screen of the cell phone 11 and manipulating the cell phone in a desirable manner. When finished, the cell phone 11 may be easily removed from the loops 10 and the straw discarded. As the user sips through the straw, the progress of the beverage through the straw may be observed.

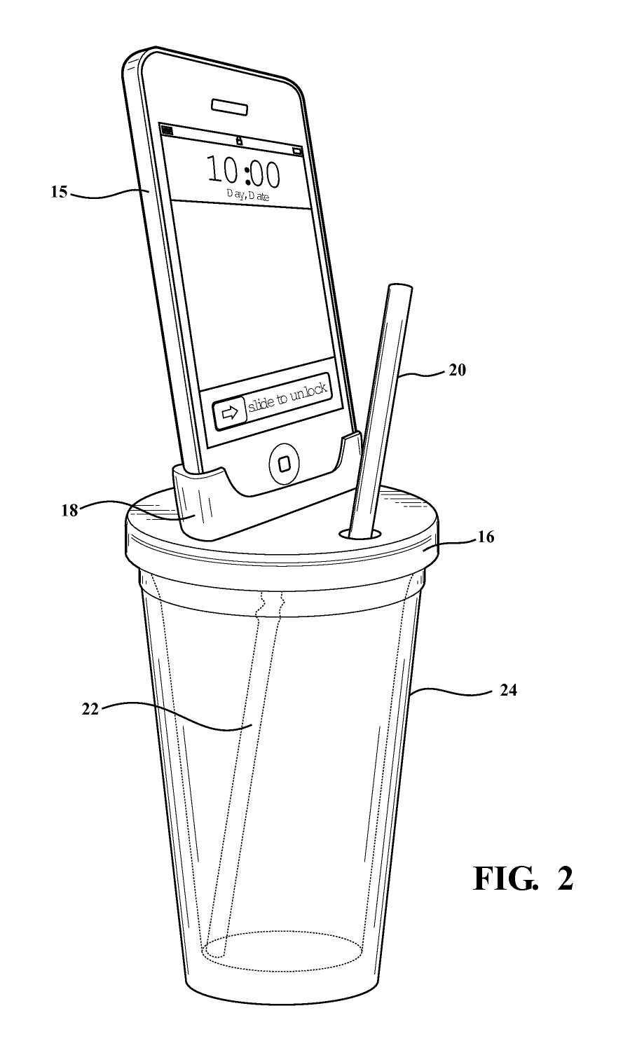

FIG. 2 illustrates a second embodiment of the invention which allows a cell phone 15 of conventional design to be supported above a disposable beverage container cap 16 so that the beverage may be consumed while observing and utilizing the cell phone.

The top side of the cover 16 is integrally formed with a bracket 18 which underlies the opposed bottom corners of the cell phone 15 and has an upward extension around the two sides of the cell phone to support the cell phone in a generally perpendicular attitude to the top surface of the cover 16. The cover is preferably formed with an integrated straw 20 which has one end projecting through the cover 16 and extending above the cover and a second end 22 extending into a beverage container 24.

Again, the user may view and operate the cell phone 15 while sipping the beverage in the container 24.

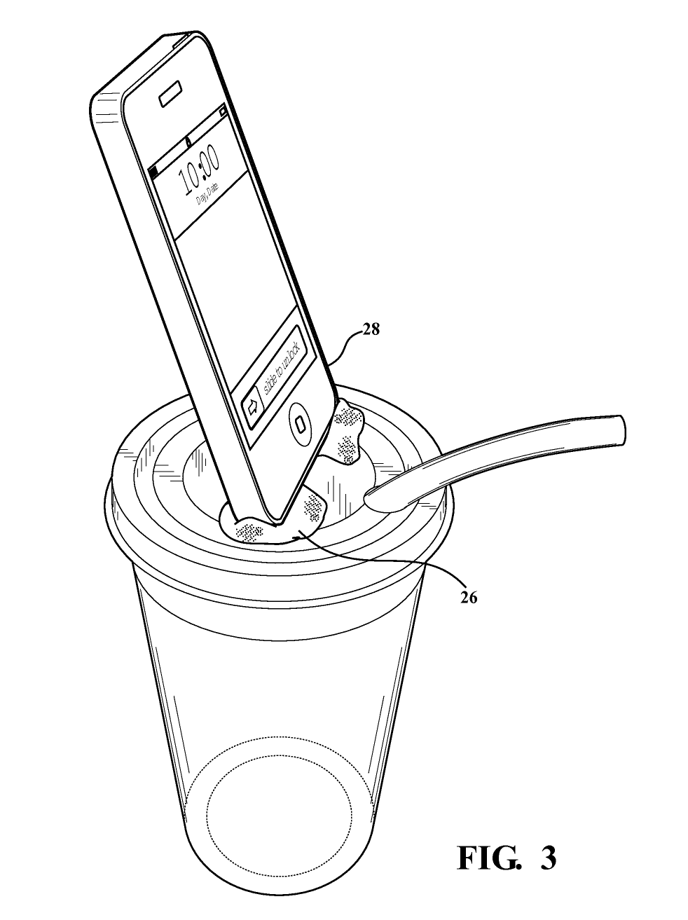

In the embodiment of the invention illustrated in FIG. 3, a manually deformable plastic volume 26 having pressure-sensitive adhesive properties on its outer surface, is disposed on the top of a beverage cover so that the lower end of a cell phone 28 may be pressed into the volume 26 and thereby supported in an upright manner on the top surface of the beverage container cover. The plastic volume will extend slightly up over the front, rear, and side surfaces of the cell phone 28 to provide a temporary support.

Having thus described my invention I claim:

1. Apparatus for engaging and retaining a removable cell phone above a disposable cup for a beverage comprising:
a recess adapted to receive a cell phone at its lower edge, without obscuring the screen of the cell phone, and to allow removal of the cell phone, allowing support of the cell phone above a beverage container while the beverage in the container is consumed through a straw.

2. The apparatus of claim 1 wherein the straw is formed of transparent plastic with two parallel loops at spaced points along its length, with each of the loops having a configuration which allows it to surround a cross section of the cell phone, with one of the loops extending parallel to and below the top end of the phone and the other of the loops extending parallel to and above the lower end of the phone; with the lower end terminating in a straw end which extends below the bottom of the phone, supports the phone, and terminates in a section substantially perpendicular to the face of the phone and the other end extends downwardly beneath the back of the phone and is adapted to be disposed within a beverage supported in a beverage container.

3. A straw for a user to sip beverage disposed in a beverage container while viewing a cell phone, comprising a pair of parallel loops spaced with respect to one another along the length of the straw, each loop enclosing an area comparable to a cross section between opposed sides of the phone, whereby a phone may be inserted into the loops, with one of the loops extending parallel to and below the top of the phone and the other loop extending parallel to and spaced from the bottom of the phone, and the phone may be selectably removed from said loops; with one of the loops terminating in an end section of the straw which extends beneath and forward of the phone supported in the loops at a generally perpendicular attitude for sipping through the straw and the other of which terminates in a section which extends downwardly with respect to a phone supported in the loops for extending into a beverage supported in a container; whereby a phone may be supported in the loops and the user may sip beverage supported in the container through the forward extending section.

4. A plastic, disposable cover for a beverage container having two brackets on its upper surface for engaging two opposed side corners of a cell phone to support the cell phone, in a removable manner, above the lid, and a straw integrated with the lid and having one end extending downwardly from the bottom of the lid for use in collecting a beverage and a second end extending above the lid and at an angle to the brackets, to allow the beverage to be sipped while observing the cell phone.

5. The lid of claim 4 wherein the brackets encompass a recess which extends downwardly from the top of the lid in the direction of the bottom of the lid.

6. The method of supporting a cell phone or the like on the upper surface of a plastic, disposable lid for a beverage container comprising placing a volume of a manually deformable plastic having pressure-sensitive adhesive outer surfaces onto the center of the top of the lid and pressing the bottom end of the cell phone into the volume of plastic so it adheres thereto and extends generally normally to the upper surface of the lid.
